(19) United States
(12) Patent Application Publication
(10) Pub. No.: US 2015/0128030 A1
(43) Pub. Date: May 7, 2015

(54) METHOD FOR INLINE IMAGE RESIZING

(71) Applicant: M/s. MobileMotion Technologies Private Limited, Bangalore (IN)

(72) Inventor: Shivansh Tyagi, Bangalore (IN)

(73) Assignee: M/s. MobileMotion Technologies Private Limited, Bangalore (IN)

(21) Appl. No.: 14/069,890

(22) Filed: Nov. 1, 2013

(51) Int. Cl. G06F 17/30

(52) U.S. Cl. CPC G06F 17/30905; G06F 17/30896
USPC 715/238

(57) ABSTRACT

The present invention provides a computer implemented method for resizing an inline image on a server. The method includes generating a Hyper-text markup language (here in after HTML) image template, receiving a request for the inline image from a mobile device by the transceiver, retrieving the image by the one or more processors, fetching display resolution of the mobile device based on the device identifier by the one or more processors and resizing the inline image by the one or more processors. The HTML image template is generated with a predetermined default resolution value. The request includes a device identifier for the mobile device. Resizing the inline image includes adjusting the resolution value of the HTML image template.

### FIELD OF INVENTION

The present invention relates to web technology and in particular, it relates to image display technique over different devices of web technology.

### BACKGROUND OF THE INVENTION

Regular users of the internet will recognize the problem that web pages often display quite differently and unexpectedly on different devices. The problem is even worse when a page is attempted to be displayed or a very small display screen, such as commonly found on a communication device or other mobile terminal.

Search engines for searching the World Wide Web (WWW) are well developed for accessing the web from a desktop personal computer (e.g. Google, Yahoo, et al). Communication devices that are capable of accessing content on the World Wide Web are being increasingly numerous. Mobile search engines prompt the user for a search term (or terms) and return mobile search results that are currently limited to links to mobile-specific websites and transcoded (automatically adapted) desktop websites. However, mobile web pages designed specifically for the small screen sizes of communication devices are very low. A mobile web page is defined as a website whose content is rendered using HTML that can be reasonably viewed and navigated within the constrained display and network capabilities of a hand held communication device or handset.

Hence, there is a need for a system and method for manipulating the content so it can be displayed on a communication device based on the display characteristics of the requested communication device.

### BRIEF DESCRIPTION OF THE INVENTION

The above-mentioned shortcomings, disadvantages and problems are addressed herein Which will be understood by reading and understanding the following specification.

In embodiments, the present invention provides a computer implemented method for resizing an inline image on a server. The method includes generating a Hyper-text markup language (here in after HTML) image template, receiving a request for the inline image from a mobile device by the transceiver, retrieving the image by the one or more processors, fetching display resolution of the mobile device based on the device identifier by the one or more processors and resizing the inline image by the one or more processors. The HTML image template is generated with a predetermined default resolution value. The request includes a device identifier fix the mobile device. Resizing the inline image includes adjusting the resolution value of the HTML image template.

In an embodiment, the method further includes storing resolution of a plurality of mobile devices on the computer readable storage medium. Each of the plurality of the mobile devices is identified with an associated device identifier of a plurality of device identifiers.

In an embodiment, the method further includes transmitting the resized image to the mobile device by the transceiver.

In an embodiment, the method further includes resetting resolution value of the HTML image template to the predetermined value.

In an embodiment, the method further includes storing the resized image on a cache memory of the mobile device.

In an embodiment, the method further includes antialiasing the resized inline image.

In another aspect, the present invention provides a system for resizing the inline image, The system includes a transceiver, one or more processors and a computer readable storage medium. The transceiver is configured to receive a request for the inline image from a mobile device and transmit resized inline image to the mobile. The one or more processors are configured to generate a Hyper-text markup language (here in after HTML) image template, retrieve the inline image; fetch the display resolution of the mobile device and resize the inline image, by adjusting the resolution value of the HTML image template with the fetched display resolution of the mobile device. The computer readable storage medium is configured to is configured to store the resized retrieved image.

In an embodiment, the computer readable storage medium is further configured to store resolution of a plurality of mobile devices on the computer readable storage medium. Each of the plurality of the mobile devices is identified with an associated device identifier of a plurality of device identifiers.

In an embodiment, the one or more processors are further configured to antialias the retrieved image.

In an embodiment, the one or more processors are configured to reset the resolution value of the HTML image template to the predetermined value.

### BRIEF DESCRIPTION OF THE DRAWINGS

FIG. 1 illustrates a system for resizing an inline image, in accordance with various embodiments of the present invention;

FIG. 2 illustrates a flowchart fur resizing the inline image, in accordance with various embodiments of the present invention;

FIG. 3 illustrates a block diagram of a server for resizing inline image, in accordance with various embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

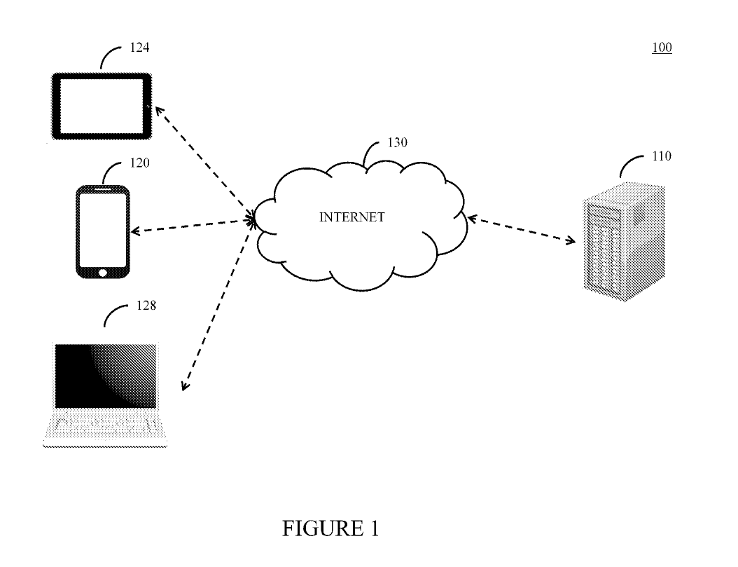

FIG. 1 illustrates a system 100 for resizing an inline image, in accordance with various embodiments of the present invention. The inline image is an image that is within the body of a webpage. The inline image in the webpage is achieved with a Hypertext Markup language (herein after HTML) image tag with one or more attributes. The example of the attributes include but may not be limited to SRC, WIDTH, HEIGHT, ALT, BORDER and ALIGN. The WIDTH and the HEIGHT attributes determine a resolution of the inline image. The SRC attribute defines link of a source from which the inline image is to be fetched.

In context of the present invention, the source of the inline image is a server 110. The server 110 generates a HTML script which includes the HTML image tag. The HTML script is part of the webpage which displays the inane image. The webpage is an aggregation of many HTML scripts put together.

In an embodiment, a user (not shown in the FIG. 1) When visiting the webpage, makes a request to the server 119 to view the inline image. The request is a Hypertext Transfer Protocol (herein, after referred to as HTTP) request. HTTP refers to a protocol for exchange or transfer of hypertext. HTTP functions as to request-response protocol in a client-server computing system. In context of the present invention, a mobile device 120 of the user is a client. The mobile device 120 communicates with the server 110 via internet 130, to send the HTTP request for viewing the inline image. Examples of the mobile device 120 include but may not be limited to, a cell phone, a smart phone, a personal digital assistant (PDA), a wireless email terminal, a laptop, a desktop computer and a tablet computer. Functions and capabilities of the mobile device 120 are same as the functions and the capabilities of a mobile device 124 and a mobile device 128.

In an embodiment, the user uses a web browser installed on the mobile device 120 to view the webpage. The web browser installed on the mobile device 120 sends the HTTP request to the server 110 to view the inline image. The examples of the web browsers include but may not be limited to, Chrome™, Mozilla Firefox™, Opera™, and Apple Safari™.

The mobile device 120 includes a display. The display of the mobile device is an output peripheral that lets the user to view information on the mobile device 120. Examples of the displays but may not be limited to, Cathode ray tube display (CRT), Light-emitting diode display (LED), Electronic paper (E Ink), Liquid crystal display (LCD), Plasma display panel (PDP), Thin-film transistor display (TFT), Organic light-emitting diode display (OLED) and Active-matrix organic light-emitting diode (AMOLED).

The display of the mobile device 120 has a display resolution. The display resolution of the mobile device 120 is number of distinct pixels in each dimension that can be displayed. The pixels are smallest addressable element in the display. The display resolution are quoted as Width×Height, with units in the pixels. The display resolution of the mobile device 120, the mobile device 124, and the mobile device 128 are different. The examples of display resolution include but may not be limited to, Video Graphics Array (640×480). wide Video Graphics Array (800×480), Full Wide Video Graphics Array (854×480), Super Video Graphics Array or Ultra Video Graphics Array (800×600), Extended Graphics Array (1024×768), Wide Extended Graphics Array(1366×768). Widescreen Super Extended Graphics Array Plus (1680×1050), Quad Extended Graphics Array (2048×1536), Quad Wide Extended Graphics Array (2048×1152), Hyper Extended Graphics Array (4096×3072). High Definition (1280×720). Full high definition (1920×1080) and Quarter high definition (960×540).

In context of the present invention, the HTTP request includes a device identifier indicating the make and model of the mobile device 120. The server 110 uses the device identifier to fetch sire of the display resolution of the mobile device 120.

In an embodiment, the server procures details of the mobile device 120 from a Device Description Repository (also referred to as DDR). The Device Description Repository is a database maintaining comprehensive mapping of device identifier and device specifications. Examples of Device Description Repositories include but may not be limited to DeviceAtlas®, WURFL®, The maDDR Project and OpenDDR.

The server 110 transmits the received device identifier to the Device Description Repository via the internet 130. On receiving the device identifier, the Device Description Repository starts mapping the received device identifier with a list of mobile devices. On successful mapping of the received device identifier with the mobile device 120, the Device Description Repository transmits the device specification of the mobile device 120 to the server 110. The device specification includes the display resolution of the mobile device 120.

The server 110 communicates with the Device Description Repository and the mobile device 120 via the internet 130 provided by a communication network. Examples of the types of the communication network include but may not be limited to, a local area network (LAN), a wide area network (WAN), a wireless network and a telecommunication network. Examples of the types of telecommunication network include but may not be limited to, a global system for mobile communication (GSM) network, a general packet radio service (GPRS) network, a code division multiple access (CDMA) system, enhanced data GSM environment (EDGE) and wideband CDMA (WCDMA).

In context of the present invention, the server 110 resizes the requested inline image based on the received display resolution of the mobile device 120. Accordingly, the server 110 transmits the resized inline image to the mobile device 120.

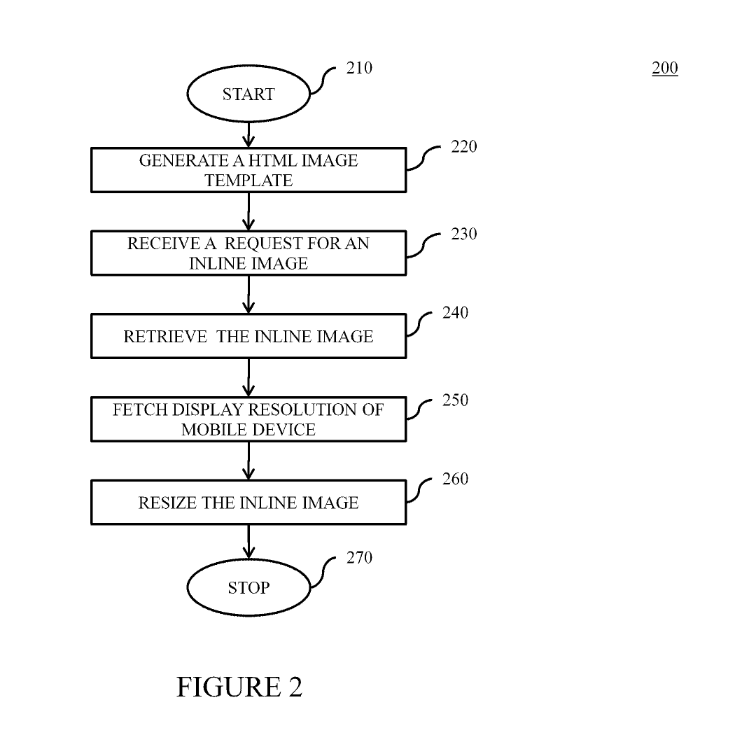

FIG. 2 illustrates a flowchart 200 thy resizing an inline image on the server 110, in accordance with various embodiments of the present invention. At step 210 the flowchart 200 initiates. At step 220, the server 110 generates a HTML image template. The server 110 generates the HTML image template with a predetermined value for the display resolution. The WIDTH and the HEIGHT attributes of the HTML image tag determine the resolution. In an embodiment, the server 110 gives a default value to the WIDTH and the HEIGHT attributes of the HTML image tag. The SRC attribute of the HTML image tag gives a link to the inline image.

At step 230, the server 110 receives a request for the inline image from the mobile device 120 of the user. In an embodiment, the web browser installed on the mobile device 120, sends the HTTP request to the server 110 to view the inline image. The HTTP request includes the device identifier of the mobile device 120.

In an embodiment, the server 110 stores device identifiers of a plurality of mobile devices. In another embodiment, the server 110 obtains the display resolution of the plurality of the mobile devices from the Device Description Repository. Accordingly, the server 110 stores the display resolution of the plurality of the mobile devices along with the corresponding device identifiers.

At step 240 the server 110 retrieves the request of inline image, stored in the server 110. In an embodiment, the inline image is stored in a third party image server. The server 110 communicates with the third party image server via the interne 130 to retrieve the inline image. Accordingly, the server 110 retrieves the inline image from the third party server.

At step 250, the server 110 fetches the display resolution of the mobile device 120 used on the received device identifier of the mobile device 120. In an embodiment the server 110 communicates with the Device Description Repository via the internet 130. The server 110 sends the device identifier of the mobile device 120 to the Device Description Repository. The Device Description Repository maps the received device identifier with the mobile device 120 of the plurality of the mobile devices. Accordingly, the Device Description Repository retrieves the device information of the mobile device 120. The Device Description Repository, on retrieving the device, information of the mobile device 120 transmits the display resolution of the mobile device 120 to the server 110 via the Internet 130. In another embodiment, the server 110 fetches the display resolution of the mobile device 120 stored in the server 110 using the received device identifier.

At step 260 the server 110 resizes the inline image based on the retrieved display resolution of the mobile device 120. The server resizes the inline image by replacing the predetermined resolution value of the HTML image template with the retrieved display resolution of the mobile device 120. Accordingly, the server 110 transmits the resized inline image to the mobile device 120 via the interact 130.

In an embodiment, the server 110 stores the resized inline image for subsequent request from a similar mobile device like the mobile device 120. In another embodiment, the web browser installed on the mobile device 120 stores the received resized inline image, on a cache memory, for the subsequent visit to the webpage.

In an example, a request to view an inline image of a resolution 1024×768 is generated from the mobile device 120 having a display resolution 640×400. The server 110 resizes the inline image by changing the resolution of the HTML image template from the predetermined delimit value to 640×400.

In an embodiment, the server 110 resizes the inline image by maintaining a constant aspect ratio. In an example, a request to view an inline image of a resolution 1024×768 is generated from the mobile device 124 having a display resolution 500×400. The server 110 resizes the inline image by maintaining the aspect ratio. Accordingly, the server 110 resizes the HTML image template by changing the resolution from the predetermined default value to 500×376.

In another embodiment, the server 110 resizes the inline image by cropping the Wine image to lit into the display resolution of the mobile device 124. In yet another embodiment, the server 110 resizes the inline image by maintaining the constant aspect ratio. Subsequently, the server 110 crops the resized inline image to fit into the display resolution of the mobile device 124. In an embodiment, the server 110 further antialiases the resized inline image.

In an embodiment, the server 110 resets the resolution value of the HTML image template to the predetermined value. On subsequent request of the inline image by the mobile device 128 having a particular display resolution, the server 110, re-sizes the inline image according to the particular display resolution.

At step 270, the flowchart 200 terminates.

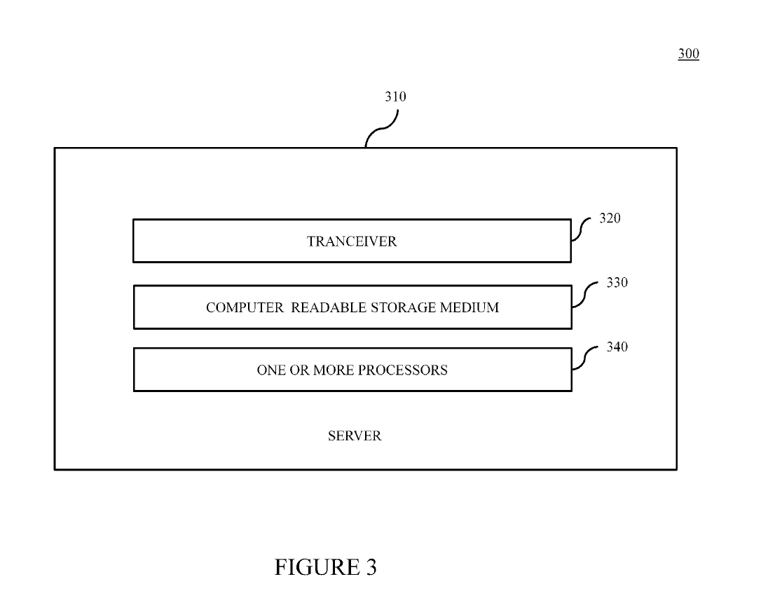

FIG. 3 illustrates a block diagram 300 of a server 310, in accordance with the various embodiments of the present invention, The server 310 includes a transceiver 320, one or more processors 330 and a computer readable storage medium 340.

The one or more processors 330 generate the HTML image template with the predetermined value for the resolution. The one or processors 330 initialize the WIDTH and HEIGHT attributes of the HTML image tag with the default value. The SRC attribute of the HTML image tag gives the link to the inline image, stored in the computer readable storage medium 340.

The transceiver 320 receives the request for the inline image to be viewed on the mobile device 120. The one or more processors 330 are coupled to the transceiver 320 to retrieve the inline image from the computer readable storage medium 340. In an embodiment, the inline image is stored on the third party image server. The one or more processors 330 communicate with the third party image server to retrieve the inline image.

In an embodiment, the transceiver 320 receives the HTTP request from the web browser installed on the mobile device 120. The HTTP request includes the device identifier to identify the mobile device 130.

In an embodiment, the computer readable storage medium 340 stores the display resolution of the plurality of mobile devices with the corresponding device identifiers. The one or processors 330 fetch the display resolution of the mobile device 120 corresponding to the mobile device 120 using the received device identifier, from the computer readable storage medium 340. In another embodiment, the one or processors 330 fetch the display resolution of the mobile device 130 from the Device Description Repository using the received device identifier. The one or more processors 330 communicate with the Device Description Repository using the internet 130. The transceiver 330 receives the display resolution of the mobile device 120.

The one or more processors 330, on fetching the display resolution of the mobile device 120, resize the inline image. The one or more processors 330 replace the predetermined resolution value of the HTML image template with the fetched display resolution of the mobile device 120. The transceiver 320 transmits the re-sized inline image to the mobile device 120. In an embodiment, the transceiver 320 transmits the resized inline image to the web browser installed on the mobile device 120.

In an embodiment, the resized inline image is stored on the computer readable storage medium 340. In another embodiment, the transceiver 320 transmits the re-sized inline image to the mobile device. Accordingly, the mobile device 120 stores the resized inline image in the cache memory of the mobile device 120.

In an embodiment. the one or more processors 330 antialias the resized inline image. Accordingly, the one or more processors 330 store the antialiased resized inline image on the computer readable storage medium 340. The transceiver 320 transmits the antialiased resized inline image to the mobile device 120. In another embodiment, the transceiver 320 transmits the antialiased resized inline image to the web browser installed on the mobile device 120.

In an embodiment, the one or more processors 330 reset the resolution value of the HTML image template to the predetermined value.

The present invention overcomes the disadvantages of conventional inline image resizing techniques. in addition, the present invention reduces the data size unlike changing the width and height in the image tag, which only resizes it inside the browser, and has no effect on data transferred. Further, the present invention antialiases the resized image thereby smoothening any jagged lines or corners. Additionally, the present invention stores the resized version so that it can be served directly. Therefore, afterwards, resources are not wasted in resizing image.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not duller from the literal language of the claims, or if they include equivalent structural elements with insubstantial differences from the literal language of the claims.

What is claimed is:

1. A computer implemented method for resizing an inline image on a server, wherein the server comprises a computer readable storage medium, a transceiver and one or more processors, the method comprising:
a. generating a Hyper-text markup language (here in after HTML) image template, wherein resolution value of the HTML image template is predetermined by the one or more processors;
b. receiving a request for the inline image from a mobile device by the transceiver, wherein the request comprises a device identifier of the mobile device;
c. retrieving the image by the one or more processors;
d. fetching display resolution of the mobile device based on the device identifier by the one or more processors: and
e. resizing the inline image by the one or more processors, wherein resizing the inline image comprises adjusting the resolution value of the HTML image template.

2. the method of claim 1, the method further comprises storing resolution of a plurality of mobile devices on the computer readable storage medium, wherein each of the plurality of the mobile devices is identified with an associated device identifier of a plurality of device identifiers.

3. The method of claim 1, wherein the method further comprises transmitting the re-sized image to the mobile device by the transceiver.

4. The method of claim 1, wherein the method further comprises resetting resolution value of the HTML image template to the predetermined value, on resizing the inline image, by the one or more processors.

5. The method of claim 1, wherein the method further comprises storing the re-sized image on a cache memory of the mobile device.

6. The method of claim 1, wherein the method further comprises antialiasing the resized inline image.

7. A system for resizing, an inline image, the system comprising:
a) a transceiver, wherein the transceiver is configured to:
I. receive a request for the inline image from a mobile device; and
II., transmit re-sized inline mage to the mobile device.
b) one or more processors, wherein the one or more processors are configured to:
I. generate a Hyper-text markup language (here in after HTML) image template, wherein resolution value of the HTML image template is predetermined;
II. retrieve the inline image;
III. fetch the display resolution of the mobile device; and
IV. resize the inline image, by adjusting the resolution value of the HTML image template with the fetched display resolution of the mobile device; and
e) a computer readable storage medium, wherein the computer readable storage medium is configured to store the re-sized retrieved image.

8. The system of claim 8, wherein the computer readable storage medium is configured to store resolution of a plurality of mobile devices on the computer readable storage medium, wherein each of the plurality of the mobile devices is identified with an associated device identifier of a plurality of device identifiers.

9. The system of claim 10, wherein the one or more processors are configured to antialias the retrieved image.

10. The system of claim 10, wherein the one or more processors are configured to reset the resolution value of the HTML image template to the predetermined value, on resizing the inline image.
